(19) United States
(12) Patent Application Publication
(10) Pub. No.: US 2003/0170093 A1
(43) Pub. Date: Sep. 11, 2003

(54) Fastening device with adjustable fastening surface embedded in cast panel or other products

(76) Inventor: David Janeway, New Westminster (CA)

Correspondence Address: MACPHERSON KWOK CHEN & HEID LLP, 1762 TECHNOLOGY DRIVE, SUITE 226, SAN JOSE, CA, 95110, US

(21) Appl. No.: 10/258,949

(22) PCT Filed: Apr. 27, 2001
(86) PCT No.: PCT/CA01/00569

(30) Foreign Application Priority Data
Apr. 27, 2000 (CA) 2,306,966

(51) Int. Cl. F16B 1/00

(52) U.S. Cl. 411/548

(57) ABSTRACT

A component (20, 22) and method for a casting process, typically for cold-process casting of concrete wall, floor, ceiling or other panels or element in situ in building construction, leaving embedded in the cast panel a fastening surface (24) which can be adjustable to allow correction of non-uniform cast surfaces. The component may be integrated to conventional form-tie systems which use ties to space removable/reusable forms, holding forms a set distance apart, and can also hold a barrier material (typically expanded foam insulation) against the inner surface of a form(s) while casting is underway; when the forms are removed, leaving a component embedded providing an adjustable surface suitable for attaching material such finishing sheet material. The component can allow adjustment of its mounting surface with respect to the cast surface and to other like components in the cast panel to provide for (substantially) uniform surface for mounting finishing materials and/or fixtures.

Copyright Notice: Some parts of this patent document contain material which is subject to copyright protection. The copyright owner, the applicant, has no objection to the reproduction by anyone of the patent document itself, once public, or the patent disclosure as it appears in the official files or records or publications of a patent registration office which has accepted the filing of this document as part of the applicant's application for patent protection, but otherwise all rights are reserved to the owner of said copyright.

### 1. FIELD OF THE INVENTION

This invention is directed to improvements in the casting of concrete or similar materials into panels such as walls, ceilings, and floors in construction of buildings and the like using removable forms, whether of wood or formed by reinforcement applied to the outside of foam insulating panels where the foam panels are left in place after casting or otherwise by provision of a device which provides a number of advantageous features over the prior art. There is also some potential use of the invention to provide some of its post-installation benefits when used in stacking foam cast forms or when retro-fitted to existing cast surfaces, or inserted into “wet” concrete post-slip-forming. In other words, the utility is not restricted to use in cast-panels alone, but extends to uses obvious to one skilled in the art in other types of construction elements.

### 2. BACKGROUND OF THE INVENTION AND PRIOR ART DISCLOSURE

Re-Usable Form Systems, Generally:

To understand the invention, it is useful to describe a typical plywood forming system. Such a system has conventional panels of wood or metal 130. (Typically, they are plywood. Usually, the system also has specially sized and shaped panels such as corner pieces and short straight pieces)

Each panel may have a series of parallel metal strengthening bands 132 running from edge to edge in a direction which is horizontal during the use of the forms.

FIG. 13 shows a form with ties 50 in place. Tie 50a is secured in one of the notches in the metal brace 132 by having a narrowed portion 52 (FIG. 5) of its shaft pass through one of the slots in a hooking member of the form's metal brace 132. It is retained in place because the narrowed portion 52 is just large enough to pass into a provided slot (not shown). The normal cross-section of tie 50 (which can be of any suitable cross section, such as round, rectangular or square) is too large to pass through slots provided. Thus, the tie is locked in position relative to the form. The other end of tie 50 has a similar narrowed portion 52, which locks it into position with respect to the form on the other side of the wall to be formed.

Form Tie Mechanisms:

Ties 50 are most usually made of metal, and remain in the wall after it is poured. They are provided with weakened portions (not shown) called a “breakback”, which can be severed using a suitable procedure after the plywood forms are removed, so that ties 50 will not then protrude from the concrete wall.

The ties may be made to conform to a variety of form panel-fastening devices, latches, and the like, and the panel latches are generally of the type designed to hold the form panels together, edge-to-edge while at the same time holding the form panels in specific alignment with the notches in the ties designed to mate with the panel-latches when closed, which by the whole system's design holds the form panels a fixed distance apart (neither spreading nor closing) before and during the pouring and casting process, to create the void within which the casting material is poured to form the (typically) cold-cast panel structure.

Fastening Surface Function:

As an additional part of the relevant prior art, it is oftentimes done in construction to embed a wooden nailer or “ladder” into a cast concrete wall panel during fabrication (of a foundation, for example) by tacking a piece of wood to the inside of one side of the form system, and then pouring the concrete into the form to cast the wall panel. When the form is removed, there is left embedded in the cast panel the wooden nailer or “ladder” which provides a nailing surface upon which things may be mounted or attached, comprised of the wooden nailer or “ladder”. This leaves the problem of weakened wall structures, concrete voids, loose nailers, uneven surfaces, the use of unsuitable and degradable materials, and unsightliness.

Form Spacing:

It is generally desirable when casting wall, ceiling or floor panels, that the forms be held a set and fixed distance apart, neither capable of coming together and thus forming a thin panel nor coming apart thus forming a thick and uneven panel and using too much material, both cases being uneconomical as well as structurally undesirable.

Incorporation of Barrier Material:

As well, when casting such panels where a barrier, of for instance thermally insulating foam sheeting, is to be formed as the outside of the cast panel (on one or both outside surfaces), it is necessary that the (foam) barrier be held tightly next to the form(s) prior to and during pouring and curing so that no voids are formed nor is the barrier allowed to intrude into the cast volume inside the forms, disrupting the continuity of the cast mass. (see, for instance, FIGS. 8, 10, 11, 13, 15, 18, 19, 20, 24, 25 and 26).

Tie Rod Function (Detailed):

Typical concrete form ties perform the function of holding a form in place relative to another form, or relative to some other anchorage. The void defined in part by the form is filed with concrete, the concrete sets, hardens and the forms may then be removed. The tie has held the form(s) to define the void within which the concrete is cold-cast to the desired shape, typically a wall or partition, foundation, floor, ceiling, or the like.

Variants on the Tie Breakback System:

Some commonly used tie systems incorporate a conical or other shaped disposable void-forming device deployed around the tie just at the inner surface of the form, to form a conical void in the concrete at the formed outer surface. This void form's function is, upon removal, to allow the tie (typically a pre-formed metal bar) to be bent back and forth until its end breaks off within the said formed conical void, so that the ties' ends are not protruding from the formed wall's surface, with no damage to the surrounding face of the wall. This breaking of the tie occurs at a pre-designed weakened point known as the tie “breakback”. The conical void, after removal of the projection portion of the tie, is either patched if exposed to weather or humidity to prevent corrosion of the broken tie's metal exposed face, or left unfilled if this is no concern. The tie, having performed its purpose, becomes redundant, structurally, with the concrete mass of the formed panel.

Other common prior art tie systems use no conical or other shaped void form at the formed concrete surface. The “breakback” designed into the ties is reactive to torsional stress, and after the forms are removed, the tie-ends are twisted with the result that the tie breaks back within the interior mass of the cast panel, leaving no protruding tie, but leaving a damaged portion of the panel surrounding the exit point of the tie prior to breakback. This damage is either patched or not, as desired, and the tie, again, becomes redundant with the mass of the formed panel.

Problems with the Prior Art with Regard to Form Tie Functions:

The prior art has disadvantages in that:

the embedded tie component cannot be utilized as an anchorage for an embedded device;

the break-back of the metal form tie results in panel surface damage and a requirement to patch;

there is no structural or optionally adjustable fastening surface or means for attachment of other things such as fixtures, handles, carriers, and the like, nor any means of positioning a foam or other barrier during (and after) casting of the panel;

the form ties leave protruding ends to be broken back, requiring additional labor and potential damage to the panel or element.

Barrier Securing Function:

In the prior art may be found many different attempt to utilize stiffened foam panels as insulation after forming, and sometimes as well, as forms themselves during a casting process, with the aim of skipping an assembly/disassembly step during and/or after the casting process, to leave insulation affixed to the formed panel as a desired end-result.

For example, see U.S. Pat. No. 5,861,105, which discloses both in its description of the prior art and in its claimed invention, a method of using temporary stiffening bars attached to the form ties to provide a type of preformed foam panel with the stiffness and positioning to withstand the forces present in the pouring and casting of concrete panels in place.

As well, in another variant of the prior art, when conventional removable wooden forms are used, preformed foam panels are inserted within the void between two forms where concrete is later poured, placed closely adjacent to one of the forms, with the aim that the resulting wall will include a thermal barrier at that one surface, formed of the foam panel, as the outside of the said wall.

Thermal or other barriers or membranes have the effect of dividing the mass of the formed panel into distinct structural elements. This complicates the engineering and building code considerations due to the structure being considered composite rather than monolithic. In the field, it is difficult to suspend a barrier within a form without rupture and movement due to head pressures developed by the uneven filling of the divided elements.

Also, this sort of technique is best suited to non-structural elements. This can be seen in the construction of pre-cast or tilt-up type of wall panels where the casting takes place on a flat surface, and where thickness is controlled prior to the application of the barrier and (optionally) a subsequent layer of concrete. (Application of the system to this use will be discussed later in further detail under the anchoring function discussion.)

Thermal insulation or other barriers bonded to a cast concrete wall at the time of casting have been attempted for some time. This has not become widespread practice due to the difficulty of lacing two forms and up to two layers of insulation together with the tie acting to restrain all elements from moving relative to one another during the pouring and casting steps.

It is difficult and time consuming to line up the hole in the form, the (up to) two foam panels and then close up the forms aligning all the ties with all the holes in the “buttoning up” procedure. This was further aggravated by the lack of a standard grid matrix that ties and tie holes would be located relative to (and thus the lack of any standard to which foam panels could be produced to fit the grid array of form ties which, when assembled, would pierce the foam layer comprised of the foam panels).

It was also difficult to assure that the insulation panels had not moved out into the concrete void due to all the adjustments required.

In the current art, there are basically two techniques used to accomplish this sort of desired end result of casting in place a thermal barrier; the use of insulated concrete forms as taught in 1286517.

Insulated Concrete Forms (ICF) are of two broad types: a pre-formed block type and a site-assembled panel, or board and tie system. Either type allows the construction of a poured concrete wall that is insulated on both sides when the concrete hardens. Both of these types of forming systems use expanded polystyrene or similar foam materials both as the contact surface as well as the backing material spanning between the support provided by flanges formed or attached to the metal or plastic or foam ties. An example of a block-type ICF may be seen in FIG. 23 (imagining that the component shown was not there).

Nailing surfaces may be provided on some of these systems either on the surface as an extension to a web or tie, or embedded within the foam face shell (FIG. 23 at 230).

The biggest application for these two systems is below grade single family residential walls, and our discussion will center around those uses.

These systems face the following problems in use:

the concrete forms' bursting strength is determined by the flexural and impact strength of the expanded polystyrene retrained by the crossties.

Consistent delivery of these required properties in face of the variables involved with the head and impact pressures of fresh concrete pours is difficult to achieve.

Typically, the practice of vibrating walls with a mechanical immersion vibrator after pour but prior to curing is discouraged due to concerns over possible rupture due to damage caused by contact of the vibrator with the foam forms and also due to concerns for the increase in form pressure brought about by liquefying the concrete through vibration.

Concerns for the complete compaction of the concrete are difficult to quantify or visually inspect, given that all exposed surfaces are covered with foam.

Concerns for water-tightness due to lack of vibratory consolidation arise out of and can be attributed to lack of consolidation around the numerous ties required to reinforce the two (foam) face shells. Most ICF manufacturers now recommend changes to normal waterproofing procedures to overcome some of these concerns.

These methods must be protected due to the strength of the foam substrate that they are bonded to, complicating the selection of material and the procedures used for back filling and soil compaction after forming.

Human factors include the requirement for certified and or specially trained installers, and or an inspection prior to concrete pour.

Installation can have a dramatic effect on both the bursting strength of the system, as well as the achieved physical properties of the wall (such as plumb, flatness, etc.) which are difficult to compensate for after the concrete sets and next to impossible to correct.

Skilled labour attempts to address these concerns.

Nailing surfaces are not adjustable to overcome these site deficiencies.

This prior art system is additionally restricted in its use for a number of reasons; it is practical only on exterior walls where thermal resistance is desired. The overall thickness of the wall is determined by the foam thickness required to contain the fluid concrete and not by the required thermal resistance. The thickness of the exterior shell adds to the overall dimension of the foundation which can effect building lot set backs as well as increasing the total building footprint. Building footprint is regulated in some jurisdictions. Thicker walls require changes to a number of building details such as width of window and door sills, etc. and adaptations from standard dimension lumber and finished parts, adding significantly to costs.

Code issues see a requirement for interior insulated surfaces to be covered with a fire rated material, such as drywall. In some jurisdictions, the use of a firewall is restricted due to the plastic ties connecting the two wall surfaces present in common commercially produced ICF systems. The use below grade in most termite areas is restricted or forbidden due to the foam providing a conduit for the insects to enter the home up the outside of the wall under the finishes.

Also in the prior art is disclosed a one-sided foam panel form option as shown in 02225262, Martineau.

That system uses the insulation as one side of the concrete form with the other side being a conventional concrete form. The system is not in widespread use and the restrictions and problems are not yet documented. Contrasting the design and concept of this system with the system we are disclosing, the following points are apparent:

In general the system has many parts, and would appear to require a skilled and trained person to assemble.

The use of a foam panel functioning as the both the form and insulation requires a high-grade foam material with technical properties.

The use of a foam panel functioning as a form requires the thickness of the material to be determined jointly by the required flexural strength of the panel, as well as the desired thermal resistance or R-value.

The Martineau foam panels require a tongue and groove edge preparation as well as a slot to be cut with precision.

A sort of nailer function is provided in Martineau, but requires an arm to pass through the concrete void and be anchored to the far side form with a pin. This restricts the location of the nailer to the edge of a formwork panel. As shown in Martineau, the arm and embedment could not function as a tie as inward movement of the form would result in the assembly hinging in the middle.

In Martineau, as contrasted with the other prior art the form tie runs along and is clipped to the tie, however no provision is given to being able to twist the tie to break it off without marring the nailer head or destroying the clip.

The nailer provided in Martineau is not adjustable. The design requires proper orientation through a slot in the foam panel to hold the foam against the form. No provision is made to allow the embedment to adapt to other tie or forming systems.

A nailer is not provided on the un-insulated wall.

The nailer does not function as part of a tie but rather lies alongside the tie.

The metal tie after the concrete sets is redundant after break back occurs.

The Martineau invention claims use only for insulated wall construction and not for any other vertical, horizontal, or after forming use.

Martineau's claim is for a forming system as a whole and not for a component for use in both formed panels and otherwise at large.

Nailing Surface or Fixturing Function:

As noted above, early practices included affixing blocks of wood to the inside of a concrete form prior to pouring concrete. When the forms were removed after the casting process this block was used as a nailer to affix temporary or permanent components to the structure. The drawbacks to this system were the variability of the wood in terms of the ability to hold the nail, the effect of swelling and shrinking of the block within the hardened concrete pocket, rotting and insect attack in some geographic areas, and the inability to quantify the engineering properties of the connection.

Metal has also been used in this role and helped eliminate some of the variables as described. The drawbacks are that one cannot drive a nail into a metal plate and that most attachments were made by either welding or threading, neither of which is suitable for light cladding or finishing materials. Additionally, metals typically had to be plated or treated to reduce the potential for corrosion surrounding the embedment and the subsequent spalling of the concrete surrounding the embedment. Plating complicates the connection further due to the effect of destroying this treated surface while drilling or welding connections to it.

Aluminum was used for a brief while until it was discovered that a reaction between the concrete and aluminum would corrode and weaken the metal in contact with the mass. The use of aluminum in contact with concrete is now discouraged or forbidden in the trade.

These complications have resulted in the retrofitting (after pour and cure of the cast panel) of most light connections in the form of furring or strapping. These two practices affix a framework to the concrete and provide a nailing or screwing surface of wood or steel.

These elements are generally attached to the structure using a drilled and anchored connection, an explosive fastener, or an epoxied or glued joint. These are labour intensive manual procedures, especially when performed overhead. Epoxies and glues are also temperature and humidity dependent, may be toxic, and are expensive.

All of these procedures also add to the overall thickness of a wall, are subject in the case of steel to rusting, and to the case of wood to rotting, warping, or insect degradation.

Both furring and strapping can overcome some job site deficiencies such as a convex or concave surface, or out of plumb orientation. In the case of strapping this is done by shimming underneath the strapping to attain a flat, plain, attaching surface. This is a labour intensive procedure and requires skilled labour.

The end result is that cladding or finishing surfaces such as drywall can be applied to cast concrete surfaces. This is sometimes done directly by gluing the drywall directly to the wall. This procedure requires a dead flat, suitable concrete surface. The use of form oil or waxy substrate, the existence of form ridges or imperfections, or a dry carbonated surface, may result in adhesive failure. This method is limited due to these factors.

The Anchoring Function:

As mentioned above anchorage is similar with the exception that all sorts of anchors can cast into concrete, whether these are rods, plates, chains, cables or the like. These are set in to the concrete prior to set and are non-adjustable after the concrete sets. All other construction procedures including concrete finishing and form stripping take place around these projecting objects.

Other existing methods of retrofitting anchorage include; drilling and inserting a deformable metal or plastic anchor, the use of an epoxy, expanding or non shrink cementitous grout, or molten metal embedding the object in a pre-formed or drilled hole, explosive fasteners, gluing or epoxying some device to the surface of the concrete.

These methods are again labour intensive, weather dependent, difficult or impossible to do overhead and require further shimming in some circumstances to provide uniform bearing or bedding of the object being anchored to the structure. In most cases the anchors or fasteners must be surface treated to prevent corrosion.

### 3. DESCRIPTION

### SUMMARY AND OBJECTS OF THIS INVENTION

It is an object of this invention to provide an apparatus and method of use of same for the purposes of mitigating or overcoming the foregoing problems found in the prior art, which:

a. embodied in the component or device, provides a stable nailing or fixturing surface within or on the surface of a cast panel such as a poured concrete ceiling, floor, or wall, which provides for an improved method of breakback of the form ties, and the fixturing surface of which is adjustable in relationship to other like devices so cast in the same surface, and to the cast surface itself, comprised of a stable, inert, non-metallic, plastic, metallic, weldable, glueable, screwable, material and surface as desired;

b. when properly used of accomplishing one or all of the following:

i. providing a means of breakback of conventional form ties without marring the formed surface,

ii. providing a means for securing a barrier material such as (but not limited to) a thermally insulating foam board to one or both sides of the cavity within a form system which is used to cast a panel such as a wall, floor or ceiling, simply and securely,

iii. providing a means of fixing material to the panel so formed, once formed, which provides for adjustment in relation to the panel's surface and to other similar devices embedded in a matrix in the casting process in the panel's face, and/or providing a means of affixing things to the panel via specialized surfaces, for example drywall or other decorative or functional (firewall and the like) panel treatments, or specialized adapters to accept, for example, threaded conduit or other hangers, and the like

iv. providing a means during the casting process of fixing conduit or reinforcing material a fixed distance from the outside surface of the eventually cast product, by acting, for example, as a bolster in the casting of a floor or tilt-up (horizontally cast) panel, while leaving a fixturing surface or device at the outside of the cast panel

v. providing a means of retrofitting a cast or other surface with an adjustable fixturing surface of desired characteristics

The invention as disclosed here also aims to mitigate or overcome a number of other prior art drawbacks, some of those with respect to inclusion of foam in forming systems being as follows:

Bursting strength in foam forms using the invention is determined by the strength of a conventional concrete forming system, and not by the insulation

the invention disclosed is less expensive, less technically stringent material can be used including recycled or part recycled plastic foams.

Blow out concerns during forming is eliminated.

The concrete can be conventionally vibrated with no concern to rupture.

Concerns on water tightness are the same as for conventional forming.

There are far fewer ties and subsequently far fewer places for voiding or bond failure to occur.

use of a one-sided application allow conventional visual inspection for concrete compaction.

Problems due to human factors are reduced by eliminating the need for special training.

Properties such as plumb or flatness are routinely and effectively dealt with in the design and erection of the conventional concrete forming system, and deficiencies can be easily overcome with the adjustable feature of the invented component.

Concrete can be insulated in a range of R-values on the inside and conventionally waterproofed and back filled on the outside.

Building footprint is unchanged.

Can be utilised in termite areas.

Concrete can be insulated in a range of R-values on the outside and left plain on the inside, eliminating the need for a fire barrier on the inside.

Exterior waterproofing issues the same as ICF with the elimination of waterproofing decisions based on the possibility of lack of concrete consolidation.

Concrete can be insulated on the outside and have a finished wall on the inside with no furring or framing required.

Minor formwork deficiencies are overcome with adjustable component feature.

Concrete can be insulated on two sides in a range of R-values to suit specific needs.

Allows conventional concrete vibration.

Eliminates bursting strength concerns.

Allows adjustment to overcome on site deficiencies after concrete hardens

The invention disclosed here has few parts and would require little or no training.

The invention disclosed here does not require high grade or virgin materials.

The invention disclosed here sees the thickness of the thermal insulation being determined by the required R-value desired.

The invention disclosed here requires a plain butted edge and a number of rough semi-circular grooves so that panel preparation is minimal and could be easily accomplished on site with simple tools.

This invention additionally allows for an anchorage to be cast into and remain flush or slightly indented below the surface during the finishing, stripping and other construction procedures. This reduces job site hazards, reduces the potential damage to the projecting anchor and the concrete surrounding it, and most importantly allows the selection of a number of potential attachments to be made and amendments to the attachment to be determined and easily accomplished much further into the construction cycle.

The invention overcomes many of the problems of uneven surfaces in cast panels by providing an adjustable, non-degrading nailing, screwing, or threading surface. This eliminates the need for furring, strapping, and shimming. This makes walls and columns take up less floor area, which is significant on high rise construction. The procedure is not weather dependent and does not require skilled labour, simply a straight edge and the tool to rotate or otherwise adjust the adjustable fixturing surface or flange. In addition, the fixturing flange can be removed and replaced to increase the adjustment or to change the fixturing material, for example, a metal adjustable flange of similar shape could be installed to provide a welding surface. Other adaptations will be discussed under the anchorage function that follows. In dealing with adding retrofit anchorage points, my invention eliminates most of the objections by allowing an adjustable and convertible anchorage that is cast in and available undamaged at the point in the construction cycle where required.

It also allows for temporary use and subsequent removal and simple patching rather than cutting, and leaves no corrodable surfaces to stain the surface or promote spalling where moisture is present. Additionally, the component comprising my invention may if required by affixed as are the prior art anchors by drilling, gluing, otherwise embedding, and the like, but the component, being adjustable, requires less precise placement, less stringent methods, and less trained labour.

### SUMMARY DESCRIPTION OF THIS INVENTION

The foregoing and similar objects may be achieved by the present invention's apparatus for use with cast or other construction elements comprising:

a. a body shaped with a generally flat outer face, with sufficient thickness to allow piercing by screw or nail or staple fasteners with a narrower inner part extending inward from the inner side of said outer face, said narrow inner part made to be cast or embedded into a panel or other construction element and

b. said inner part comprising one or more sub-components which provide means of being adjusted in a direction perpendicular to the surface of the construction element within which it has been cast or embedded, and where said inner part has more than one sub-part, said inner part's adjustment means comprises two sub-parts, an outer sub-part which is cast and held within the construction element, and an inner sub-part which is permanently fixed to said outer face, and which is adjustable within the said outer sub-part in a direction (essentially) perpendicularly to the face of the formed surface within which the entire body and notably the outer sub-part is cast or embedded.

It will be apparent that there are a number of uses for the component or apparatus as described here, and as described in detail below.

### BRIEF DESCRIPTION OF THE DRAWINGS

FIG. 1 shows a side and an end elevation of an exemplary single-piece component

FIG. 2 shows an end and side elevation with cross-sectional details of an exemplary two-piece component

FIG. 3 shows two elevations of an exemplary two-piece steel coil anchor component

FIG. 4 shows two elevations of an exemplary two-piece steel coil anchor component for insulated slab applications

FIG. 5 shows two elevations of an exemplary one-piece component with optional spring to integrate in conventional form-tie systems

FIGS. 6 and 7 show manual insertion of the component into horizontal and vertical “wet” concrete surfaces

FIG. 8 shows the component used as a cast-in-place anchor and fastening surface with and without insulation

FIGS. 9 through 13 show examples of the component in use in a cross-section of an integrated form-tie system with forms in place

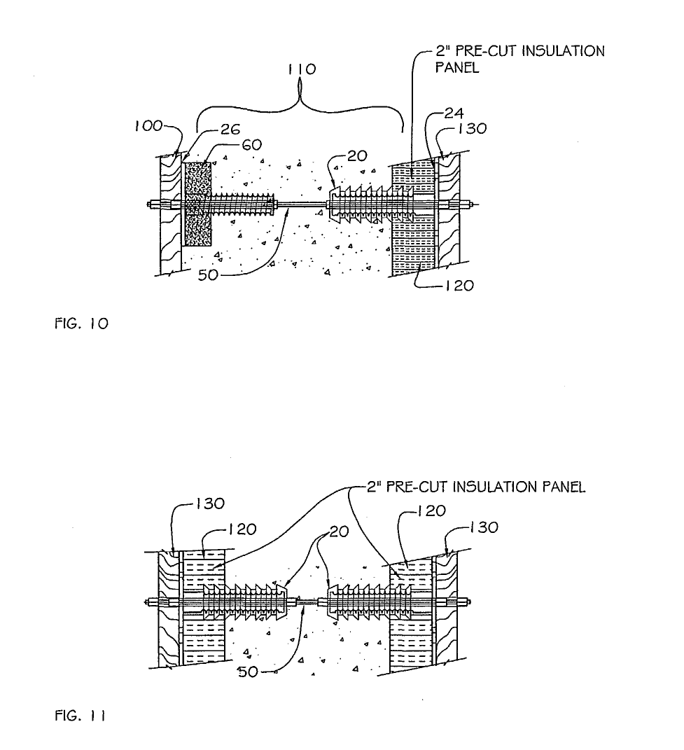

FIGS. 14 and 15 show the component in use in a form system independent of the tie system in cross-section

FIGS. 16 through 19 show the component in use in insulated and uninsulated slab systems in cross-section

FIGS. 20 and 21 show the component used as an adjustable fastener, in cross-section, in both uninsulated and insulated walls, both in and out of plumb

FIGS. 22 and 23 show the component in use in oblique transparent elevations in concrete block (22) and ICF forms (23)

FIG. 24 shows the component in use in a conventional form-tie system with one-sided internal insulation, in phases, as an oblique elevation

FIG. 25 shows the component in use in a conventional tilt-up concrete panel fabrication, as an oblique elevation

FIG. 26 shows the component in us in a conventional two-sided insulated tilt-up concrete panel fabrication, as an oblique elevation, in two steps

### DETAILED DESCRIPTION OF ONE EMBODIMENT OF THE INVENTION

It is to be clearly understood that all the within-described types of arrangements, manufactures, and installations are to be construed as falling within the scope of the present invention, and are made as illustrations of the invention claimed, an not by way of limitation.

The description of these embodiments of this invention is intended to be illustrative and not limiting. Other embodiments of this invention will be obvious to those skilled in the art in view of the above disclosure and the claims made below.

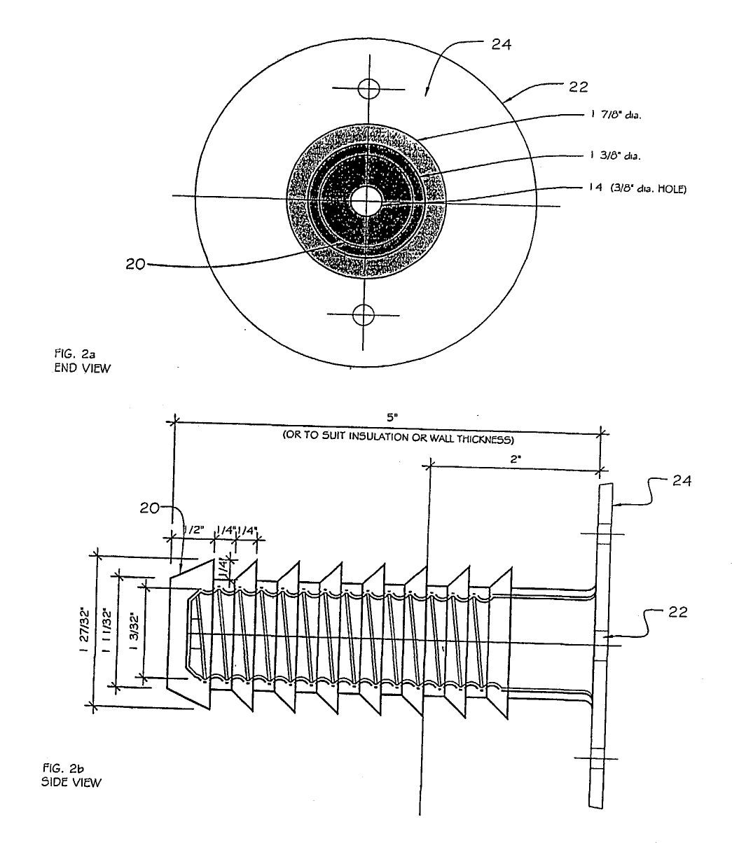

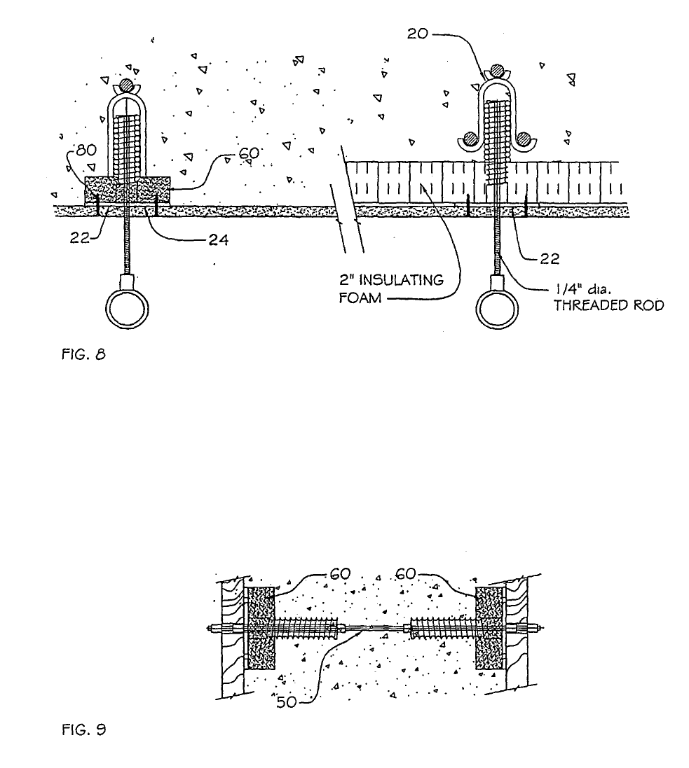

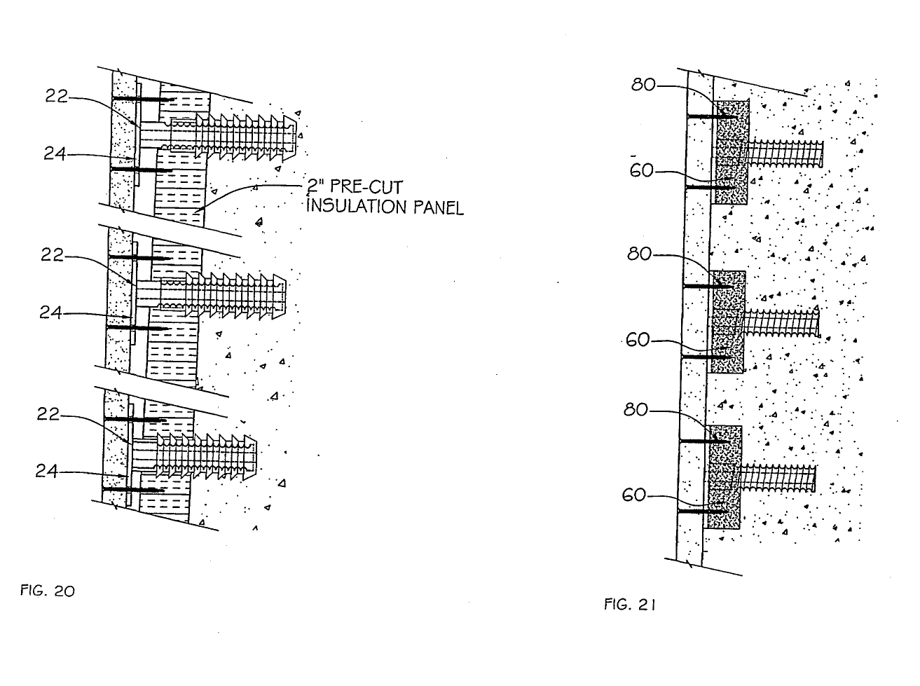

The device in the two-part embodiment is comprised of a body in two parts, the embedded part 20 being designed (shape and material) such that it will when embedded in a cast panel such as of poured concrete, be held within the cast panel and be difficult to remove. A simple drawing of such a shape is seen in FIG. 2, at 20. The said embedded part 20 is internally threaded (or similarly adjustably engageable with the second part 22) axially through its centre and substantially perpendicularly to the outer surface of the panel within which it is to be embedded, to accept the second part 22 which is composed of the threaded or similarly adjustable engagement means with the said embedded part 20, and a larger outer face or flange 24, designed to be parallel with the outer surface of the panel within which the device as a whole will end up being installed. The said larger face or surface 24 has holes or other suitable means of engaging a tool or finger with which the said second part 22 can be turned or otherwise adjusted so that the outer plane of said larger face 24 or surface can be moved further or closer to the plane of the surface of the formed panel (as in FIG. 20), while remaining substantially parallel thereto. If said adjustment means is a central threaded system as shown in the drawings, said larger face or-surface 24 should be substantially circular so that it can be easily turned within the space its body has formed during the forming process in the panel's creation. Depending upon the application (that is, where the thickness of the part of the device behind the said larger surface 24 is not sufficiently deep to allow the planned fastener such as a screw or nail to hold, for example where said fastener is longer than the depth of said thickness), it will be necessary to cast in place behind the said second part a washer 60 of foam or other suitable material or cup or other means to hold the casting substance (such as concrete) out of the space adjacent to and behind the said larger face 24 or surface of the device 22 to allow a fastener to essentially pierce the thickness of that part of the device 24 and enter the space held by said washer 60 without damaging the fastener or the second part of the device (as in FIGS. 8 and 21 at 80).

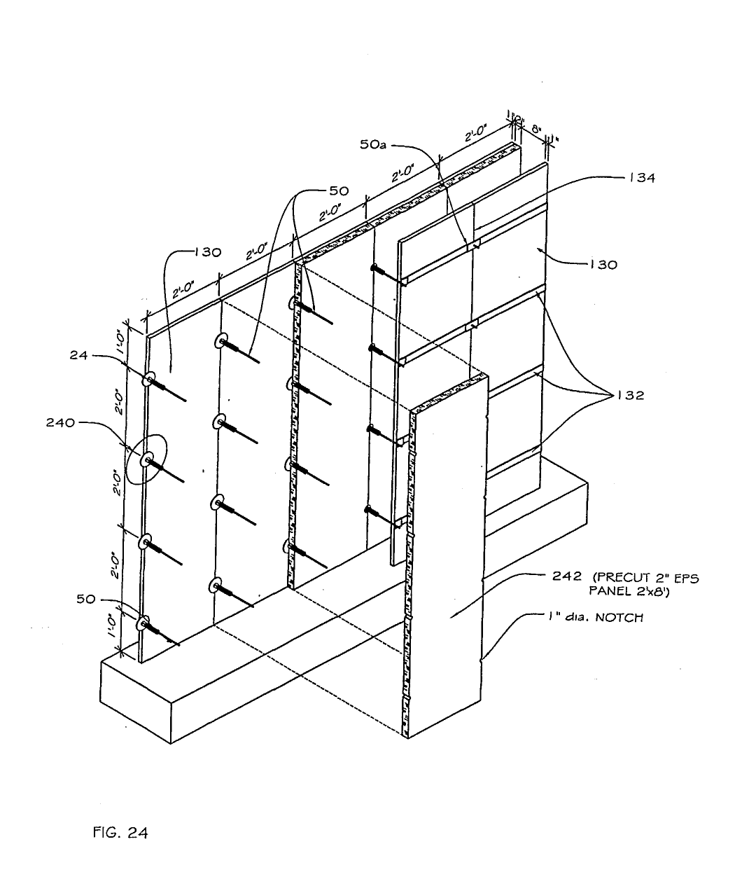

When used in conjunction with a conventional re-useable form and tie panel casting system such as was described in the prior art section of this document (above), the device 24 will be threaded (as a needle is threaded) onto the tie 50 which protrudes, typically from the assembled outside form 130 during the form and tie system's use, and placed adjacent to the inner surface of said outside form (for example at FIG. 24 at 240). Where a foam insulating barrier 242 is desired to result on the outer surface of the formed panel, said foam barrier is constructed with semi-circular indents at pre-determined locations on the edge of its component panels to be fitted around the device 24 and to allow the device which is frictionally or otherwise fixed to the tie 50, to hold the foam panel 242 frictionally by the fit of the semicircular indent to the device 24 tightly adjacent to the said outside form's inner surface. For example, at FIG. 10, tie 50 is threaded through plywood form 100, one of the devices 26, a spacer washer 60, the void of the form 110, the inner part of a two-part device 20, insulating foam 120, the outer adjustable part 24, and the outer plywood form 130.

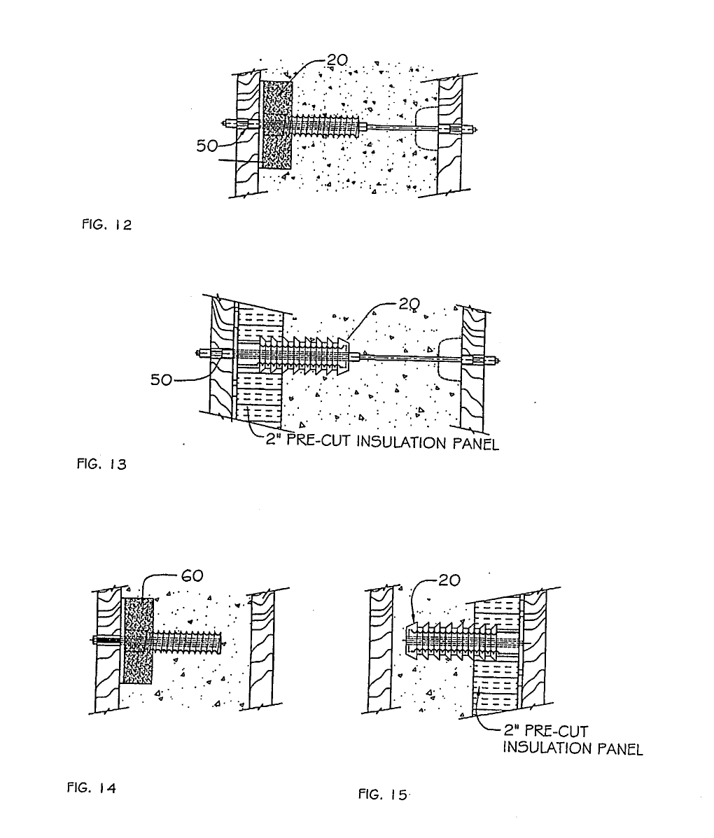

The device may be attached to either form at pre-determined or desired locations without having been threaded onto a form tie, to provide a specifically located fixturing surface embedded in a formed panel (FIGS. 14 and 15 illustrate this use).

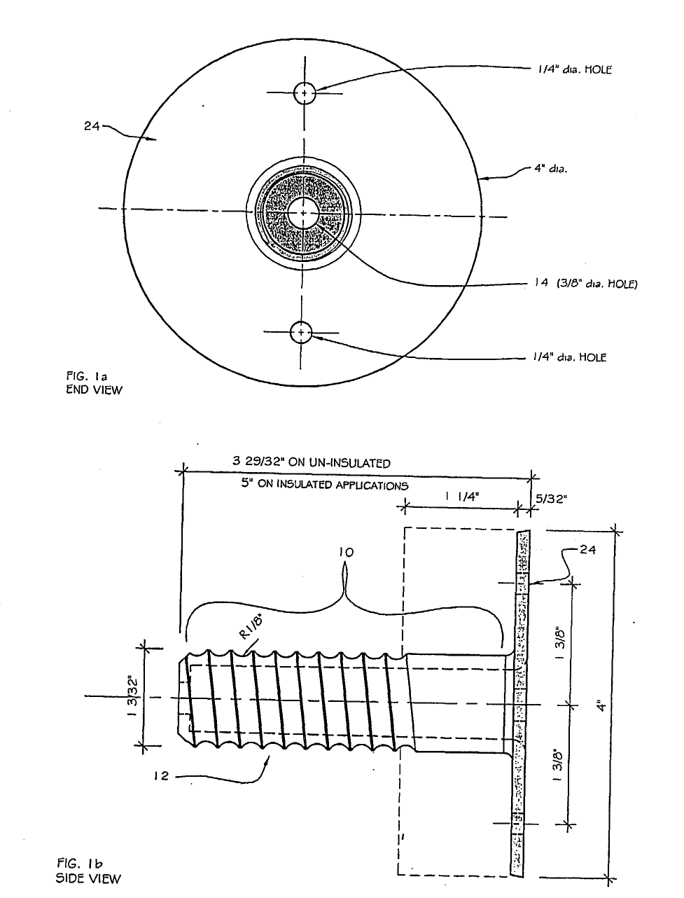

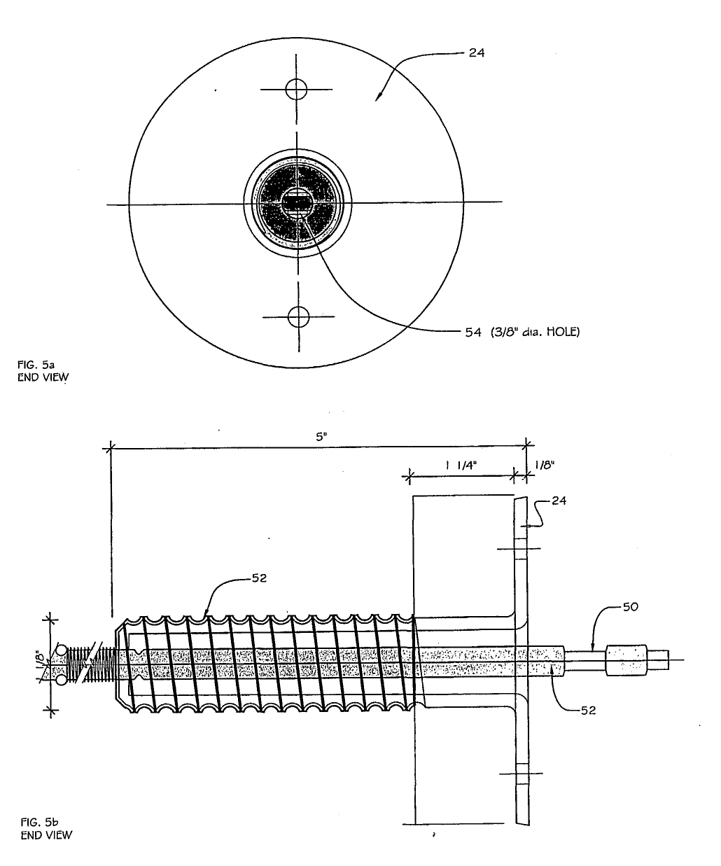

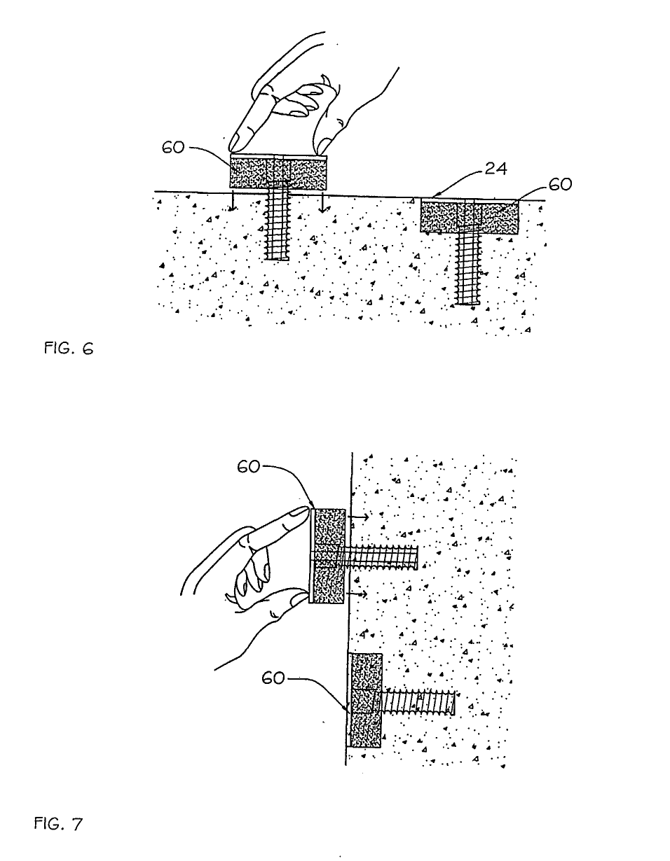

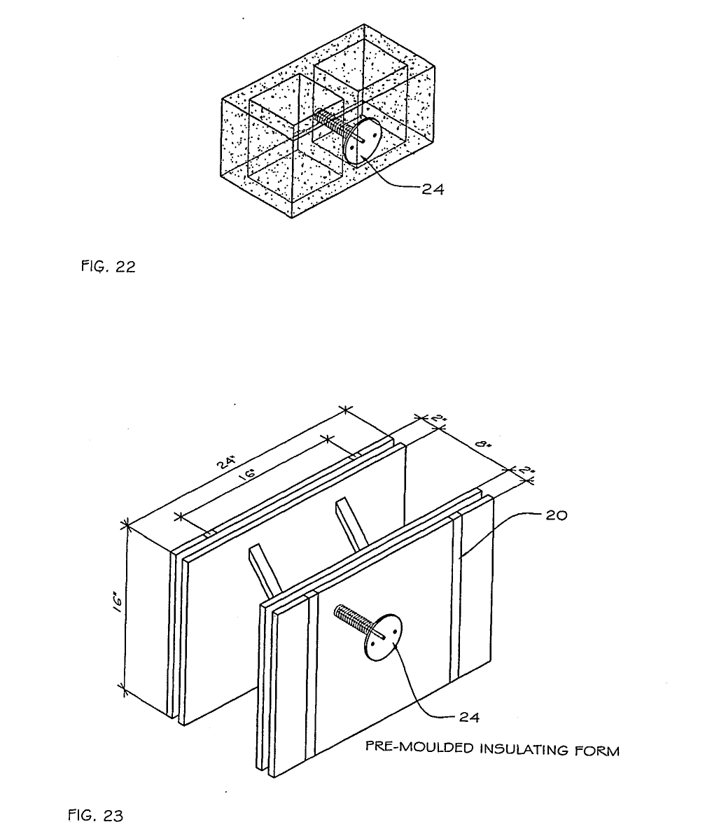

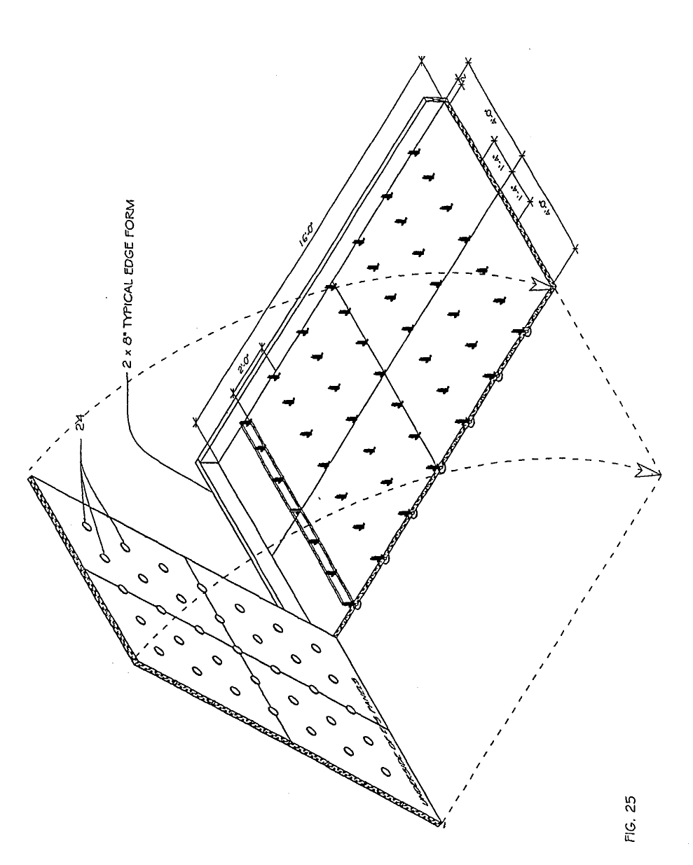

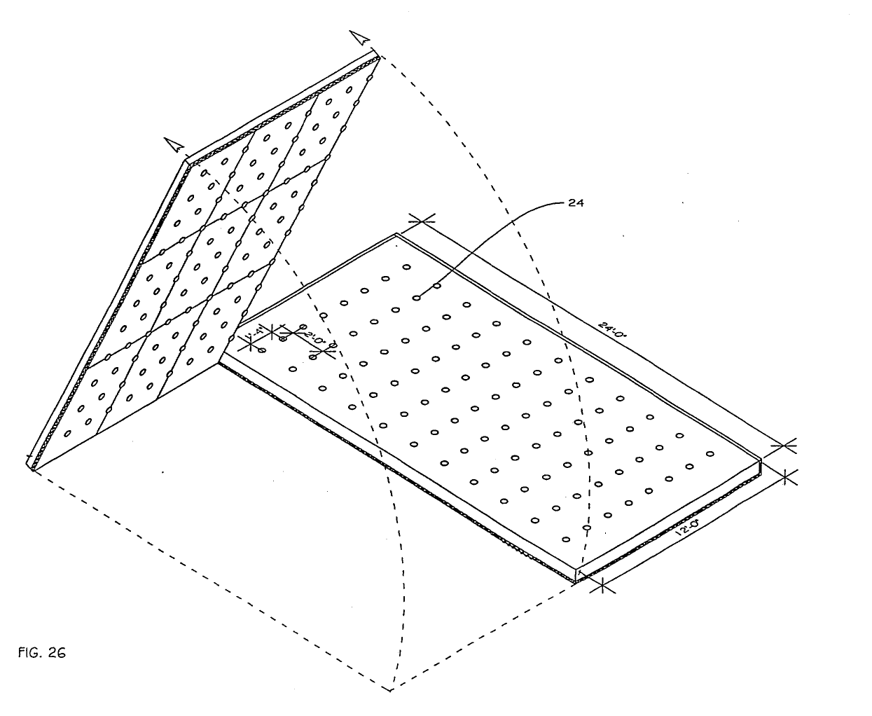

FIG. 1 shows an example of a one-piece component embodying this invention. It has a large diameter outer face 24 and an inner part 10 which carries a male thread 12 on most of its outer surface. The component has a hole 14 through its longitudinal centre for use in form-tie applications to receive a conventional form tie 50. At FIG. 5, the component is shown with a shrink-wrapped cover 52, which enables it to be turned in and out of a panel within which it has been cast by rotating its threads within the threaded bore formed during casting, the coating 52 providing a barrier to prevent bonding of the component to the cast material (if required). Examples of uses of such a one-piece component are shown: in FIG. 6, where one is inserted into a “wet” concrete surface to form its mating female threaded bore for use; In FIG. 7, likewise into a vertical such surface; in FIG. 12, as one end of a conventional form-tie system to provide an adjustable nailer; at FIG. 14, by being nailed to a form without a tie to provide an adjustable nailer; at FIG. 21, in series, cast into a wall panel in a grid pattern to form an array of adjustable nailers to provide a uniform fastening surface without furring and likewise again at FIGS. 24 through 26; at FIG. 22, cast in place in a typical concrete “cinder block”; at FIG. 23, in a pre-molded ICF block wall form.

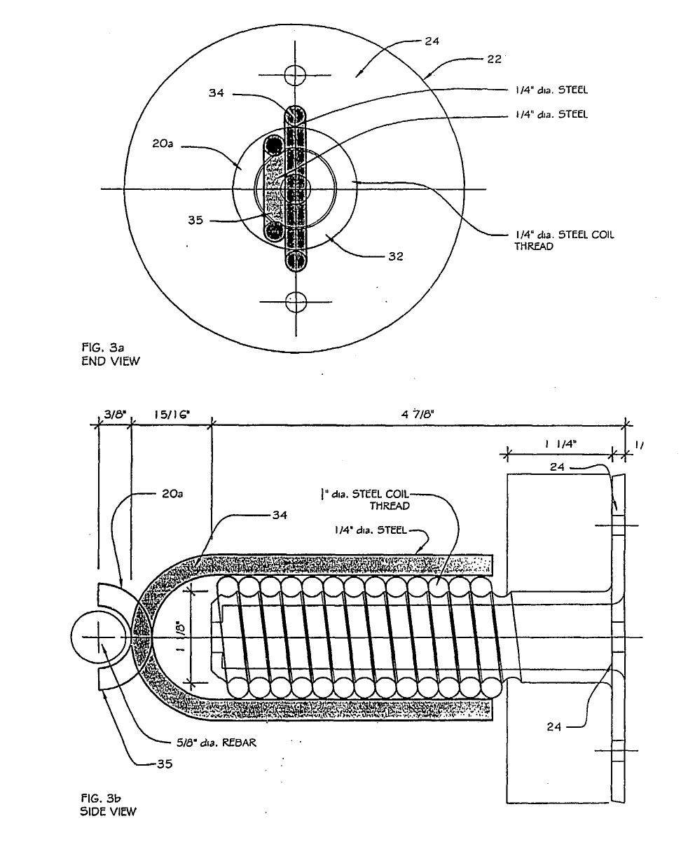

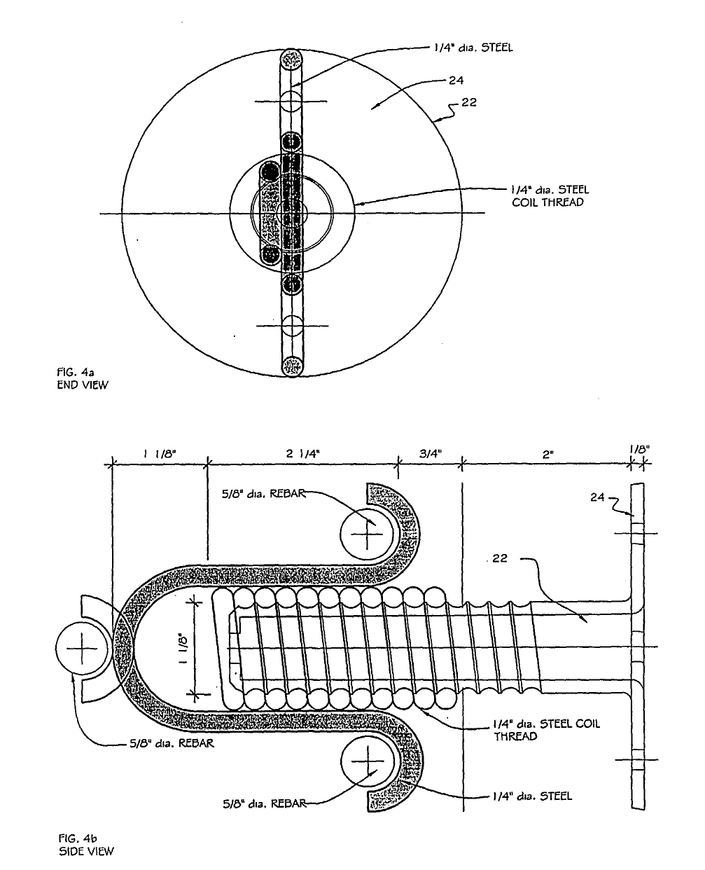

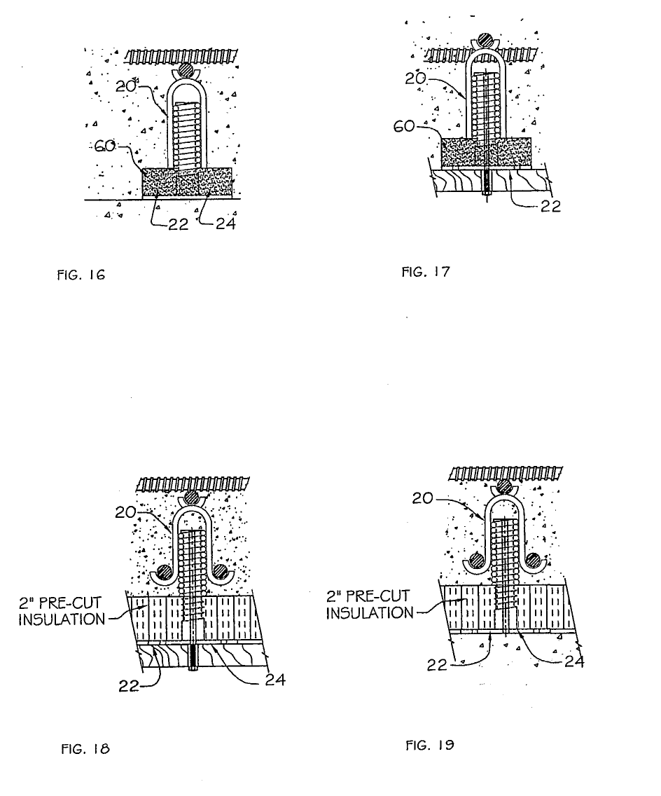

In its two-piece embodiment, a variety of inner parts are provided by example: In FIG. 2 is shown a plastic anchor part 20 with female threaded interior passage to receive threaded male inner part of component 24, the anchor having a second purpose in some applications (as shown in FIGS. 10 and 11, holding insulation panel 120 against the form 130 during pouring in a conventional form-tie system). Similarly in FIGS. 13, 15, and 20. At FIG. 3, the inner second embedded part 20a is formed of a wire coil 32 the inner passage of which forms a threaded female receptacle for the component's other part 20, which coil is welded to a form comprised of metal loops 34 and 35, where 35 forms a receiver to hold a re-bar part or conduit in place in a horizontal formed panel prior to and during the pouring process (see FIGS. 8, 16 and 17). FIG. 4 shows another embodiment of such a bolster, as do FIGS. 18 and 19.

A variety of implementations and uses of the device in the forming of panels is displayed in the drawings, use as a bolster with a spacer to hold reinforcement bars in place during pouring and curing of a ceiling, wall, or tilt-up cast panel (where the pour and curing takes place on a horizontal orientation, with only one form-side (the bottom) is required (aside from edge barriers during pouring in place), variants of the detailed description using the device in a conventional form and tie system with and without insulating foam barriers is also shown.

As shown in FIGS. 6 and 7, the device can be retrofitted into existing panel or surface situations and bonded into place with glue, mortar or other suitable adhesive to provide for a desirably placed adjustable fixturing surface to the said panel.

One of the primary results of the invention's use will be the adjustable fixturing surface 24 which can be moved in relationship to others of its kind and to the surface within which the device is embedded, and to thus provide curative means for unevenly poured panel surfaces, off-plumb (or off-level) panel surfaces as in FIG. 20, or as a substitute for adhesives on a plumb and even panel surface as in FIG. 21.

Note that these situations are illustrative and not limiting, and that by their example, one skilled in the relevant art will immediately perceive a number of other situations where the invented device will prove useful.

I claim:

1. An apparatus for use with cast or other construction elements comprising:
a. a body shaped with a generally flat outer face, with sufficient thickness to allow piercing by screw or nail or staple fasteners with a narrower inner part extending inward from the inner side of said outer face, said narrow inner part made to be cast or embedded into a panel or other construction element;
b. Said inner part comprising one or more sub-components which provide means of being adjusted in a direction perpendicular to the surface of the construction element within which it has been cast or embedded.

2. An apparatus as in claim 1, where the thickness provided in said outer face to permit piercing by fastening means is provided by placement behind said outer face and around said inner part of a spacer to accept said fastening means, and to avoid filling the space required to utilize said fastening means with the substance of the construction element or material being used to cast or form said apparatus within said element.

3. The apparatus in claim 1, shaped and constructed of a material or with suitable friction-relieving coating upon said inner part, such that when said apparatus is cast within a cast or formed material of said construction element, the outer surface of the said narrow inner part of the apparatus causes the formed material to assume a shape which, in interaction with the said narrow inner part so coated provides the said means of adjustment.

4. The apparatus in claim 3 where the said inner part is formed on its outer surface of a male thread and the formed material once cast and hardened forms a mating female thread.

5. The apparatus in claim 3 where the said adjusting means is provided by a frictional fit formed of adjacent ring-shaped outer protuberances along the shaft of the said narrow part, which protuberances are made to compress enough to allow tightly fitted but moveable engagement with matching ring-shaped detents formed within the female void formed during casting by the shape of the said apparatus' narrow part.

6. The apparatus in claim 1 where said inner part's adjustment means comprises two sub-parts, an outer sub-part which is cast and held within the construction element, and an inner subpart which is permanently fixed to said outer face, and which is adjustable within the said outer sub-part in a direction (essentially) perpendicularly to the face of the formed surface within which the entire body and notably the outer sub-part is cast or embedded.

7. The apparatus in claim 1 where said outer face has shape and characteristics suitable for a purpose other than fastening, such as a hanger, bolster, prop, hook, stand, or receptacle.

8. The apparatus in claim 1 where said outer facets to hold a barrier next to the inner surface of a form used in the casting of panels or other construction elements.

9. The apparatus in claim 8, having a void within itself extending essentially linearly through its body about a central line perpendicular to the surface of the element within which it is cast or embedded, suitable to surround a form tie of conventional design and constructed to perform the same function as a conventional form tie in addition to its other inherent functions.

10. The apparatus of claim 9, said inner void being shaped to include means to be affixed to a conventional form tie and to thus form part of the temporary form structure, holding said apparatus against the inner surface of said form and assisting to hold said form to a proper distance along said form-tie such that the void formed by the said form and tie system is of desired configuration.

11. The apparatus of claim 9, acting in horizontal panel forming operations as a bolster or shim to hold reinforcing material such as re-bar and/or conduit such as for electrical, communications, plumbing, control and/or other lines fixed in a desired location within the volume to be formed by casting in said forming operations.

12. The apparatus of claim 11, as well being capable of receiving means of lifting and/or manipulating the thing (such as a tilt-up cast panel) within which it is cast or embedded in said forming operation.

13. The apparatus of claim 1 and claim 6, being capable of having affixed to its outer part a hangar, rod, or other device from which ceilings, fixtures, or other finishing or construction elements may be hung using said adjustment means.

14. The apparatus of claim 1 and claim 6, used by being inserted within a foam or masonry stack element prior to or during the assembly of that unit into a wall or other panel or construction element by masonry or casting or forming or combination methods.

15. A method of casting panels or other construction elements using conventional forms with the apparatus provided herein, where the panel is a ceiling, floor, wall, or divider.

16. A method of preparing a construction element such as a cast surface, for accepting a finishing material or covering to be mounted on the apparatus, once retrofitted.

17. A method of pouring a tilt-cast panel with conduit and structural reinforcement in place, located and held using the apparatus provided herein.

18. A method of providing hangars from the lower surface of a cast combined floor and ceiling in large-scale cast-in-place construction.
